(19) United States
(12) Patent Application Publication
(10) Pub. No.: US 2017/0082857 A1
(43) Pub. Date: Mar. 23, 2017

(54) DISPLAY DEVICE FOR A MOTOR VEHICLE, MOTOR VEHICLE AND METHOD FOR OPERATING A DISPLAY DEVICE

(71) Applicant: VALEO Schalter und Sensoren GmbH, Bietigheim-Bissingen (DE)

(72) Inventors: Lars Schoch, Bietigheim-Bissingen (DE); Daniel Kuntze, Bietigheim-Bissingen (DE); Karl Simonis, Bietigheim-Bissingen (DE)

(73) Assignee: VALEO Schalter und Sensoren GmbH, Bietigheim-Bissingen (DE)

(21) Appl. No.: 15/309,292

(22) PCT Filed: Apr. 10, 2015
(86) PCT No.: PCT/EP2015/057850

§ 371 Date: Nov. 7, 2016

(30) Foreign Application Priority Data
May 8, 2014 (DE) 10 2014 106 498.4

(51) Int. Cl. G02B 27/01; B60R 11/02; G02B 1/11; B60K 35/00

(52) U.S. Cl. CPC G02B 27/0149; B60K 35/00; B60R 11/0229; G02B 27/0101; G02B 1/11; B60K 2350/2052; B60K 2350/405; B60R 2011/0005

(57) ABSTRACT

The invention relates to a display device (1) for a motor vehicle, having a mirror (2) which is arranged so as to be movable between a stowage position and a usage position, a first movably arranged covering element (3) which, for the movement between a stowage position and a usage position, is coupled to an electromechanical drive, and a second movably arranged covering element (4), wherein the display device (1) has a stowage position, in which the mirror (2) and the two covering elements (3, 4) are arranged in a respective associated stowage position, and a usage position, in which the mirror (2) and the two covering elements (3, 4) are arranged in a respective associated usage position, and in the stowage position, the two covering elements (3, 4) at least partially cover the mirror (2), wherein the second covering element (4) is, at least in the stowage position, preloaded by a spring element, in order to save structural space.

The invention relates to a display device for a motor vehicle, having a mirror which is arranged so as to be movable between a stowage position and a usage position, a first movably arranged covering element which, for the movement between a stowage position and a usage position, is coupled to an electromechanical drive, and a second movably arranged covering element, wherein the display device has a stowage position, in which the mirror and the two covering elements are arranged in a respective associated stowage position, and a usage position, in which the mirror and the two covering elements are arranged in a respective associated usage position, and in the stowage position, the two covering elements at least partially cover the mirror. The invention likewise relates to a motor vehicle having a display device of said type and to a method for operating a display device of said type.

Known display devices in motor vehicles utilize mirrors to display information by projecting it in a specific direction. These normally involve so-called combiner mirrors or combining mirrors which have a semitransparent mirror surface by way of which it is made possible for information projected onto the mirror and which is reflected by said mirror to be superposed on information visible through the mirror from surroundings situated behind the mirror. If the display device is not required, the mirror is for example retracted or folded into a mirror compartment in order to be protected.

For example, US 2012/0176683 A1 proposes a positioning system for a combining mirror, by means of which the combining mirror can be moved into a usage position and, there, a readjustment of an angular position of the combining mirror is performed. DE 40 11 495 C1 also describes a display device in which a mirror can be positioned differently. In a stowage position, the mirror is folded in and protected by a cover.

Known embodiments have numerous components and multiple motors for the drive of the covers for the mirror.

It is an object of the present invention to provide a display device for a motor vehicle, a motor vehicle having a display device of said type, and a method for operating a display device of said type, which display device and motor vehicle have a construction which is simplified in terms of drive for the movement of the components.

Said object is achieved according to the invention by way of a display device, a motor vehicle and a method according to the independent patent claims. A display device according to the invention for a motor vehicle comprises a mirror which is arranged so as to be movable between a stowage position and a usage position, a first movably arranged covering element which, for the movement between a stowage position and a usage position, is coupled to an electromechanical drive, and a second movably arranged covering element. The display device has a stowage position, in which the mirror and the two covering elements are arranged in a respective associated stowage position, and a usage position, in which the mirror and the two covering elements are arranged in a respective associated usage position. In the stowage position, the two covering elements at least partially cover the mirror. The stowage position is thus a closed position in which no optical display by way of the mirror is possible. The usage position is an open position in which an optical display on the mirror is possible and the mirror is in particular folded out or deployed. The respective stowage positions and usage positions of mirror and the two covering elements are in this case end positions of a travel path covered by the respective components between the stowage position and usage position of the display device. It is essential to the display device according to the invention that the second covering element is, at least in the stowage position, preloaded by a spring element, in order to minimize the structural space required by the display device. This has the advantage that an additional drive, or an additional kinematic mechanism which is coupled to the existing drive, for the second covering element is not required and can thus be omitted. Thus, structural space for additional kinematic components is saved, and the movement of the components is simplified in terms of drive. Moreover, by way of the spring element, an automatic opening is possible, that is to say an automatic movement of the second covering element from the stowage position into the usage position without a dedicated drive. The second covering element is thus also free from play in said end position owing to the preload.

The mirror may in particular be a combining mirror, that is to say a mirror with a semitransparent mirror surface which not only reflects light but also transmits light, such that reflected and transmitted light are superposed.

In a preferred embodiment, it is provided that, in the stowage position of the second covering element, the second covering element is mechanically coupled to the first covering element and is held by the first covering element, in particular in the stowage position of the first covering element. This has the advantage that no separate locking mechanism is additionally required, and therefore wear, number of components and space requirement are reduced by way of a simplified mechanism. The spring force of the spring element is thus counteracted by way of said coupling of the covering elements, such that the second covering element cannot move out of the stowage position in an undesired manner owing to the preload.

In a further embodiment, it is provided that, over a first travel path segment of the first covering element proceeding from the usage position, the first covering element is mechanically decoupled from the second covering element. The first travel path segment is in this case a travel path segment covered by the first covering element from the usage position into the stowage position and which in particular directly adjoins, or starts at, that end position of the covering element which defines the usage position. This has the advantage that the first and the second covering element can, proceeding from the decoupled state, move into the respective usage position independently of one another, such that, in particular, an asymmetrical construction with, for example, different sizes of covering element can be easily realized despite the construction which is simplified in terms of drive. This independency also yields additional freedom in the specific design of the display device that can be utilized for a saving of structural space.

In a particularly advantageous embodiment, it is provided that, over a second travel path segment of the first covering element as far as a point at which the stowage position of the first covering element is reached, the first covering element is mechanically coupled to the second covering element. Here, the mechanical coupling over the second travel path segment yields the major advantage that the second covering element can be moved counter to the spring stress by the first covering element. Thus, the second covering element can be moved back and forth between the usage and stowage positions by way of the spring element and the first covering element, entirely without a dedicated drive. Further components, which are susceptible to wear and which take up structural space, are thus not required.

The travel path covered by the first covering element from the usage position to the stowage position can thus be divided into a first travel path segment, which adjoins that end position of the travel path which corresponds to the usage position, and a second travel path segment, which adjoins that end position which corresponds to the stowage position. In particular, the two parts of the travel path thus form, without overlap, the entire travel path of the first covering element from the usage position into the stowage position. In particular, when the stowage position of the first covering element is reached, the second covering element is then also in the associated stowage position.

In particular, the mechanical coupling may be designed such that, by way of an in particular linear displacement of the first covering element, the second covering element is moved conjointly. This yields the advantage of a particularly simple construction, in the case of which no further kinematic mechanism, in particular no further transmission means has to be connected between the first and the second covering element.

Here, it may particularly advantageously be provided that the first covering element has at least one, in particular peg-like coupling element which, over the second travel path segment, engages into a guide slot of the second covering element, with the mechanical coupling being implemented in this way. This has the advantage that a direct coupling exists between the two covering elements, whereby it is possible to realize a particularly simple construction with few components. Furthermore, by way of the specific shape of the guide slot, the extent and effect of the mechanical guide can be easily adapted to the given requirements.

In a preferred embodiment, it is provided that the second covering element has an axis of rotation and is pivotable into the associated stowage position and usage position in each case by way of a rotation about said axis of rotation. This has the advantage that a pivoting mechanism can be designed in a particularly space-saving manner. Specifically if the first cover is moved back and forth between stowage position and usage position by way of a translational movement, this can be mechanically coupled to the rotational movement in a particularly simple and direct manner.

In a further embodiment, it is provided that the second covering element is of U-shaped form with two side webs, that is to say in the form of a bridge in the case of which the side webs correspond to the bridge pillars, and an in particular funnel-shaped guide slot is arranged on an in particular inner side surface of at least one side web. If appropriate, it is also possible here for one side web to be dispensed with, and for the second covering element to be of correspondingly L-shaped form with one side web. This has the advantage that the covering element is stabilized by the side webs and thus particularly stable guidance and movement of the covering element is possible. Optimum space utilization is realized by way of the arrangement of the guide slot on the inner side, because in this way, the side webs can be arranged very close to an outer housing of the display device. It is also possible for the guidance and movement of the covering element to be realized in a simple, stable and reliable manner by way of a component, in particular the first covering element, which is at least temporarily arranged between the side webs.

In another embodiment, it is provided that the first and/or the second covering element has a light-absorbing surface on an inner side which, in the stowage position and/or in the usage position, faces toward the mirror. This has the advantage that, in this way, distracting reflections in the usage position are prevented, and an altogether more compact construction is thus made possible.

In a preferred embodiment, it is provided that the mirror is mechanically coupled to the drive of the first covering element and can be pivoted by said drive. This has the advantage that only one drive is required for the two different components, which saves space and costs.

Here, it may be provided in particular that the mirror has a carrier bracket which is mechanically coupled at least to a guide slot which is integrated, in particular laterally integrated, with a toothed wheel of a mechanism of the drive. This has the advantage that, by way of the specific shaping of the carrier bracket and of the guide slot, the movement of the mirror and of the first covering element can be optimally coordinated with one another, such that both components can, despite the relative movement with respect to one another, be arranged very close together without abutting against one another during the movement between stowage position and usage position. The carrier bracket preferably comprises a main carrier or central region on which preferably U-shaped or V-shaped carrier arms are arranged at opposite ends.

In a preferred embodiment, it is provided that the first covering element has an integrated, in particular rectilinear, toothed structure which meshes, in particular directly meshes, with a toothed wheel of the drive. This has the advantage that the first covering element is moved or displaced in a space-saving, simple and robust manner. Owing to the integration or unipartite form of the covering element and of the toothed structure, assembly outlay can be reduced, and undesired relative movements between the toothed structure and the covering element can be prevented.

In an advantageous embodiment, the display device is in the form of a head-up display. The mirror is then in particular the combining mirror of a display device of said type.

The invention also encompasses a motor vehicle having a display device according to one of the described embodiments or a combination thereof.

The invention likewise encompasses a method for operating a display device for a motor vehicle, in which method a movably arranged mirror, a first movably arranged covering element which, for the movement between a stowage position and a usage position, is coupled to an electromechanical drive, and a second movably arranged covering element are moved between a stowage position of the display device and a usage position of the display device. In the stowage position, the mirror and the two covering elements are arranged in a respective associated stowage position, and in the usage position, the mirror and the two covering elements are arranged in a respective associated usage position. Here, in the stowage position, the two covering elements at least partially cover the mirror. In order to operate the display device in as small a structural space volume as possible, the second covering element is, at least in the stowage position, preloaded by a spring element.

It is thus in particular the case here that, in the stowage position of the display device, the first covering element, in particular in its associated stowage position, holds the second covering element in its associated stowage position counter to a force of the spring element. Now, if the first covering element moves along a travel path from the stowage position into the usage position, it is in particular the case that the first covering element decouples from the second covering element. Driven by the spring element, the second covering element then moves, in particular by way of a rotation about an axis of rotation, in particular into the associated usage position. The first covering element is moved into its associated usage position by way of the drive, in particular by way of a toothed wheel of the drive, which toothed wheel meshes with a toothing integrated into the first covering element. It is then also the case that the mirror is moved from its stowage position into the usage position in particular by way of the same drive, via in particular the same toothed wheel, such that, finally, the entire display device has been moved into the usage position. The movement of the first covering element and of the mirror may in this case take place partially simultaneously.

From the usage position of the display device, a movement into the stowage position is realized in particular by way of a movement of the mirror into the stowage position by way of the drive. Here, it is in particular also the case that the first covering element moves in the direction of its stowage position. Here, it is possible in particular for a mechanical coupling between the first covering element and the second covering element to be realized over a second travel path section or second travel path segment of the total travel path from the usage position into the stowage position, wherein, at the end of the second travel path section, the first covering element has arrived in its stowage position. Here, it is possible in particular for a coupling element of the first covering element to engage into a guide slot which is formed in particular in a side web of the second covering element, which in this case is of U-shaped form, and to thus move the second covering element into the stowage position counter to the stress of the spring element.

Further features of the invention will emerge from the claims, from the figures and from the description of the figures. All of the features and feature combinations mentioned above in the description, and the features and feature combinations mentioned below in the description of the figures and/or shown in the figures alone, may be used not only in the respectively specified combination but also in other combinations or individually without departing from the scope of the invention. Thus, embodiments of the invention which are not explicitly shown and discussed in the figures but which emerge and can be generated by way of separated feature combinations from the discussed embodiments are also to be regarded as being encompassed and disclosed.

Exemplary embodiments of the invention will be discussed in more detail below on the basis of schematic drawings.

In the drawings:

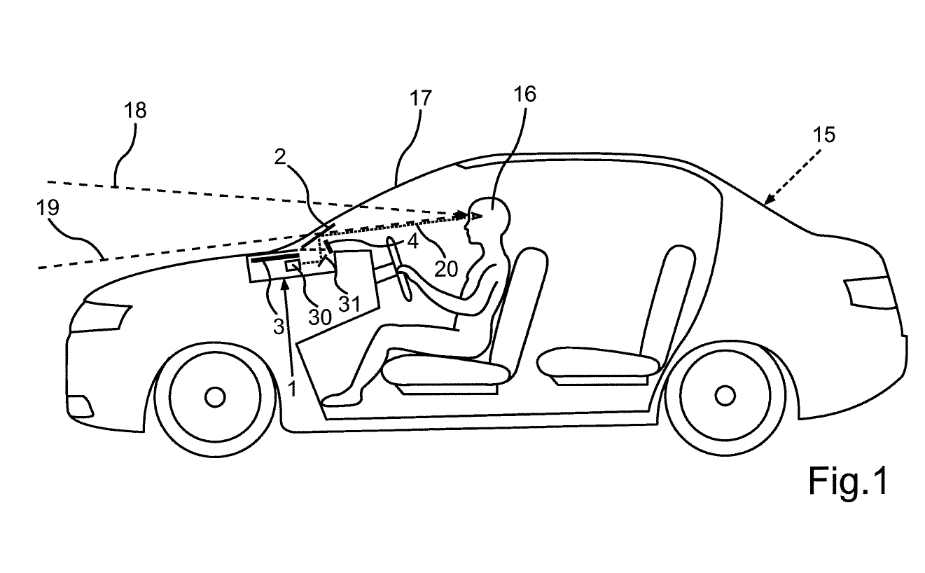

FIG. 1 is a schematic sectional illustration of a motor vehicle having an installed exemplary embodiment of a display device according to the invention;

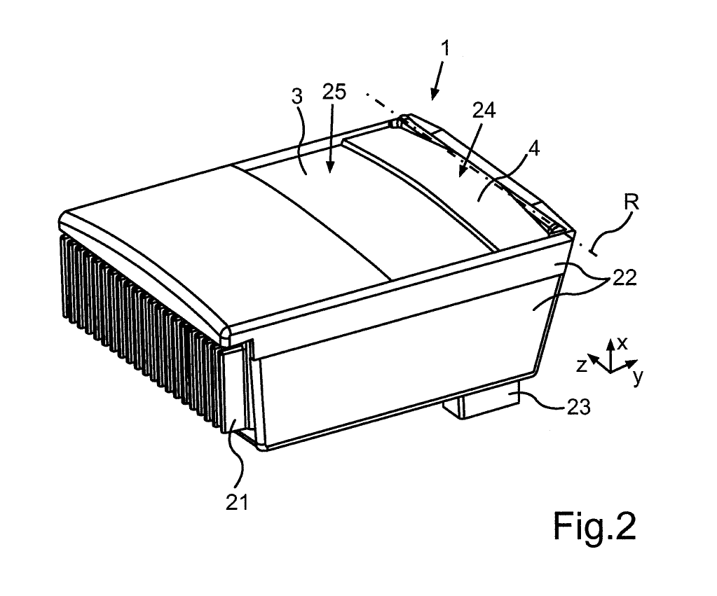

FIG. 2 is a schematic illustration of a display device according to an exemplary embodiment of the invention in a stowage position;

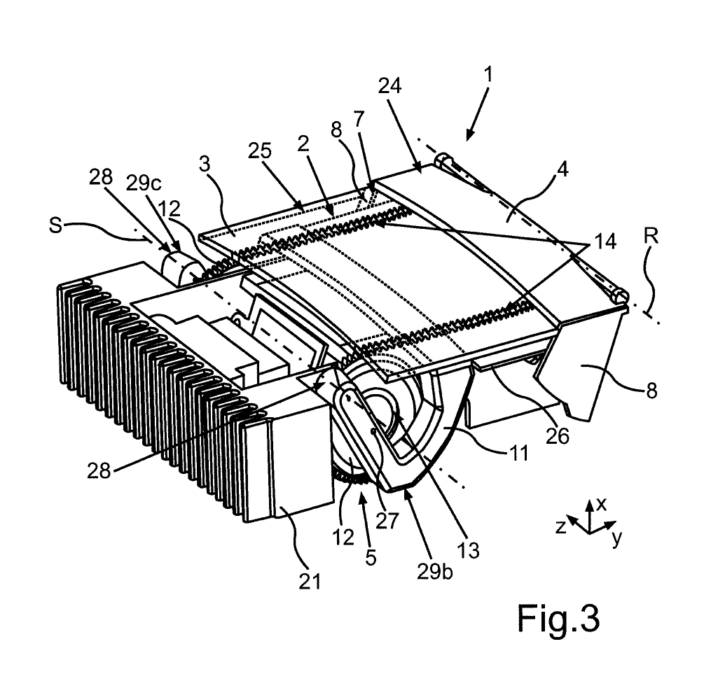

FIG. 3 shows the exemplary embodiment illustrated in FIG. 2 without a housing cover; and

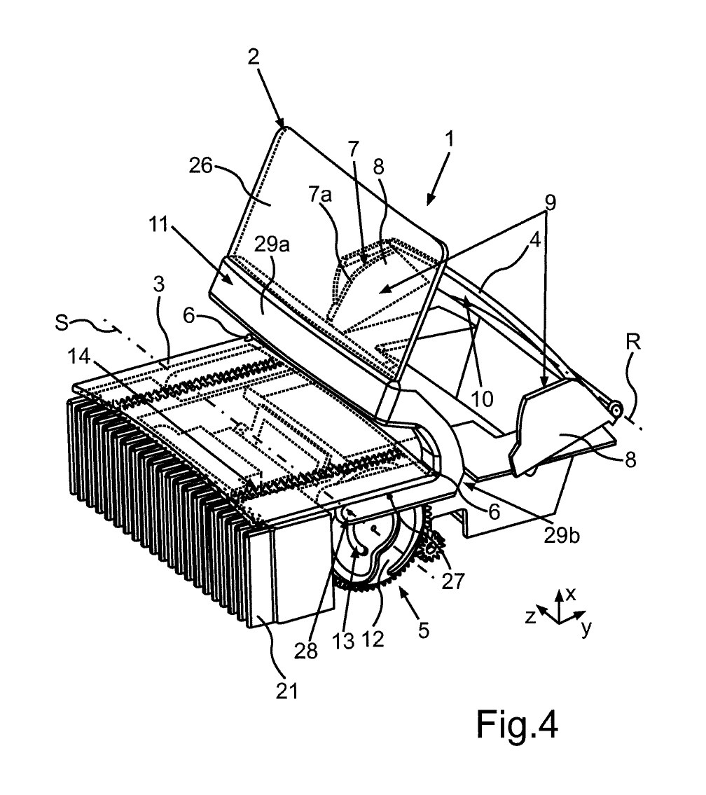

FIG. 4 shows the exemplary embodiment illustrated in FIG. 3 in a usage position.

In the figures, identical or functionally identical elements are denoted by the same reference designations.

FIG. 1 is a schematic sectional illustration of a motor vehicle having an installed exemplary embodiment of a display device 1 according to the invention, which in this case is formed and arranged as a head-up display. A display device 1 is in this case arranged by way of example in a dashboard of a motor vehicle 15, in front of a driver 16 as viewed in a direction of travel. Incident light from surroundings of the motor vehicle 15 can be seen by the driver 16 through a windshield 17. On a first light path 18, light from the surroundings passes directly to the eye of the driver 16. Light passing to the eye of the driver 16 via a second light path 19 firstly passes through the windshield 17 and then through a mirror 2 of the display device 1. Light which passes to the driver 16 on the second light path 19 however additionally has light superposed on it which passes to the driver 16 on a third light path 20, which is in part identical to the second. On the third light path 20, light passes to the driver 16 which has been emitted by a light signal source 30 of the display device 1 and which is projected, for the purposes of displaying information, onto the mirror 2 of the display device 1. In the example shown, to lengthen the optical path while realizing a small structural space requirement, a further conventional mirror 31 is incorporated into the third light path 20. Since, in the example shown, the light of the second light path 19 passes through the mirror 2 at exactly the same point and at the same angle as the light of the third light path 20 strikes the mirror 2 and is reflected, the light of the second light path 19 and the light of the third light path 20 passes to the driver 16 in superposed form. The driver is thus provided simultaneously with information from the surroundings, which has passed to him or her on the second light path 19, and with information from the display device 1, which has passed to him or her on the third light path 20. He or she therefore does not need to avert his or her view from the windshield 17 in order to see information from the display device 1 and vice versa.

FIG. 2 is a schematic illustration of an exemplary embodiment of a display device 1 in a stowage position. The display device 1 has, in the example shown, a substantially cuboidal housing 21 which is largely surrounded by a housing cover 22. Said housing cover 22 has, on a top side, that is to say on a side situated in a positive x direction, a cutout which extends substantially in the z-y plane and which, in the stowage position shown here, is closed off by a first covering element 3 and a second covering element 4. Here, of the two covering elements 3, 4, it is possible to see only their respective outer sides 24, 25. Thus, in the stowage position, an optical deflection of light to the driver 16 (FIG. 1) is not possible. In the present case, for a movement into a usage position, in which an optical function can be performed, the first covering element 3 must be pushed linearly under the housing cover 22 in a negative y direction. By contrast, the second covering element 4, in order to reach a usage position, must be pivoted into the usage position about an axis of rotation R, which is arranged at a side, situated in the positive y direction of the cutout, closed by the two covering elements 3, 4, of the housing cover 22. In the present case, said axis of rotation R runs parallel to the z axis. In an installed state of the display device 1 in a motor vehicle 15, only the top side, which extends substantially in the z-y plane, is visible. By way of a connector 23, the display device 1 can then be supplied with electrical energy, and data signals and/or control signals can be exchanged.

FIG. 3 illustrates the display device 1 illustrated in FIG. 2 without a housing cover 22 (FIG. 2). Here, it can be clearly seen that the first covering element 3 in this case has, on an inner side situated opposite the outer side 25, a toothed structure 14 with which, in the present case, two toothed wheels 12 of a drive 5 directly mesh. Since the toothed structure 14 in the example shown extends rectilinearly in the x direction, a rotation of the toothed wheels 12 results in a linear displacement of the first covering element in the x direction. As described above, in this example, the first covering element 3 is pushed under the housing cover 22 (FIG. 2).

Here, there is likewise mechanically coupled to the toothed wheel 12 of the drive 5 a carrier bracket 11 which, together with a mirror surface 26, forms the mirror 2 in the example shown. In the stowage position, the mirror surface 26 extends underneath the two covering elements 3, 4 in the z-y plane, that is to say in the negative x direction substantially parallel to the covering elements 3, 4. The carrier bracket 11 is attached to that edge of the mirror surface 26 which is situated in the negative y direction, that is to say which points away from the axis of rotation R in the present case. Said carrier bracket has a central region 29a (FIG. 4) and two end regions 29b, 29c, which constitute carrier arms. The mirror surface 26 is fastened to the central region 29a. The central region 29a transitions, at the opposite sides of the carrier bracket 11 in the z direction, into in each case one end region 29b, 29c. Here, the end regions 29b, 29c are in each case symmetrical. In this example, the end regions 29b, 29c have a U-like or V-like curved shape, the bend of which extends in the x-y plane, that is to say in the present case perpendicular to the plane of the mirror surface 26.

Here, the two U-shaped or V-shaped end regions 29b, 29c have free ends 28 situated in the negative y direction. Said ends 28 are connected in each case by way of a shaft to the housing 21. By way of the shaft, the mirror 2 with the mirror surface 26 and the carrier bracket 11 can be pivoted about a pivot axis S running through the shaft. To couple the pivoting about the pivot axis S to a movement of the toothed wheels 12, the two U-shaped or V-shaped end regions 29b, 29c of the carrier bracket 11 in this case have pins 27 which engage into a guide slot 13 which is formed laterally into the respective toothed wheels 12. Thus, if it is the case during a rotation of the toothed wheels 12 that the first covering element 3 is displaced in the present case linearly by way of the meshing with the toothed structure 14, in the embodiment shown a rotational force is exerted on the carrier bracket 11 and thus on the mirror 2 by way of the guide slot 13, which in this case is formed laterally on the respective toothed wheels 12, by the pins 27. Thus, during a rotation of the toothed wheels 12, the mirror 2 is pivoted about the pivot axis S from the stowage position shown here into a usage position.

In the present case, the second covering element 4 has, in addition to the features already shown in FIG. 2, two side webs 8 which, in the example shown, are arranged in an x-y plane perpendicular to the axis of rotation R and substantially perpendicular to the outer side 25 of the second covering element 4. Here, the side webs 8 have in each case one guide slot 7 on the respective inner side surfaces 9 (FIG. 4). A guide slot 7 is engaged into by a coupling element 6 of the first covering element 3, which coupling element is in the present case in the form of a peg and can be clearly seen as such for the first time in FIG. 4. Thus, in the example shown here, in the stowage position, the first covering element 3 slides between the side webs 8 of the second covering element 4 and engages there into the guide slot 7.

Thus, in the stowage position, the second covering element 4 is held in the stowage position 6 by the coupling elements 6, which in the present case are designed as pegs, of the first covering element 3 counter to the spring force of a spring element, which may be a leaf spring or a spiral spring. If the drive 5 is now set in motion in order to move the display device 1 from the stowage position into the usage position, the toothed wheels 12 are set in motion. Since said toothed wheels directly mesh with the first covering element 3 by way of the toothed structure 14, it is thus the case that the first covering element 3 is displaced in the negative y direction. The guide slot 13 of the toothed wheel 12 is in this case designed such that initially no force is transmitted to the carrier bracket 11 of the mirror 2. Rather, the pin 27 of the carrier bracket 11 slides through the guide slot 13 without transmitting force. Since the first covering element 3 now moves away from the second covering element 4 in the direction of its usage position and the coupling elements 6, which are in this case designed as pegs, and thus no longer hold the second covering element 4 in the stowage position counter to the spring force of the spring element, the second covering element 4 will, proceeding from a certain point of the displacement movement, move automatically into the usage position under the action of the spring force. Over an, in this respect, second travel path segment of the first covering element 3, measured between the stowage position and that point of the displacement movement at which the second covering element 4 and the first covering element 3 decouple, it is thus the case here that mechanical coupling between the first covering element 3 and the second covering element 4 is still realized by way of the coupling elements 6 and the guide slots 7. At the stated point of the displacement movement, the toothed wheels 12 have then rotated to such an extent that the two covering elements 3, 4 decouple. Proceeding from this point, the second covering element 4 is then automatically moved, by the spring force of the spring element, into the usage position over a then adjoining first travel path segment. There, the second covering element 4 is preferably still subjected to a preload by the spring element, such that said usage position is also maintained in stable fashion and also withstands the vibrations during operation of the motor vehicle 15 (FIG. 1).

At a certain point of the rotation of the toothed wheels 12, which may be reached before, after or at the same time as that point of the displacement movement at which the decoupling of the covering elements 3, 4 occurs, the guide slot 13 transmits a force to the pin 27 and thus to the carrier bracket 11 of the mirror 2. Then, the mirror 2 is set in motion. When the mirror 2 and the two covering elements 3, 4 have reached the usage position, the rotation of the two toothed wheels 12 is then also stopped.

FIG. 4 illustrates the display device 1 from FIG. 3 in the usage position. The figure shows that the second covering element 4 has been folded out, that is to say pivoted about the axis of rotation R into the usage position. The funnel-shaped guide slot 7 on the inner side surfaces 9 of the side webs 8 of the second covering element 4 is also shown. The inner side 10 of the second covering element 4, which in the present case is provided with a light-absorbent coating, is also illustrated. The first covering element 3 has likewise reached its usage position. Correspondingly, said first covering element has been displaced in the negative y direction to such an extent that the toothed wheels 12 have now reached the end, situated in the positive y direction, of the toothed structure 14 integrated into the first covering element 3, that is to say have meshed with said end. The mirror 2 is also now arranged, having been pivoted about the pivot axis S, in its usage position. The mirror 2 thus protrudes out of the open housing 21, in the installed state out of the cutout shown in FIG. 2, and can perform an optical display function. The structure of the guide slot 13 on the toothed wheel 12, which guide slot holds the pin 27 and thus the mirror 2 in the usage position, is shown here.

In the usage position, light generated in the display device 1 is reflected on the mirror surface 26 of the mirror 2 and is superposed on light from surroundings, in particular on light which, in an installed state of the display device 1, has been transmitted through a windshield 17 (FIG. 1). If it is now sought for the display device 1 to be retracted from the usage position into a stowage position, for example because the function of the display device 1 is not required, then it is the case in this example that the electromechanical drive 5 sets the toothed wheels 12 in rotation. The guide slot 13 of the toothed wheels 12 is for example designed such that the first covering element 3 and the mirror 2 are set in motion simultaneously. Since the end region 29b, 29c of the carrier bracket 11 is in this case at a sufficient distance from the first covering element 3, and moreover, in this example, in that section of the end region 29b, 29c which in the usage position projects beyond the first covering element 3 in the positive x direction, has in this case a radius of curvature which increases in the x direction, a transmission of force or a collision between the first covering element 3 and the mirror 2 is prevented. Thus, in the present case, the first covering element 3 is displaced straight forward in the positive x direction, and the mirror 2 is folded in by way of a pivoting movement about the pivot axis S, simultaneously. In an alternative embodiment, it would for example also be possible for the displacement of the first covering element 3 into the stowage position to take place only after the mirror 2 has been fully folded into the stowage position. After the first covering element 3 has then covered a first travel path segment proceeding from the usage position, said first covering element will for example abut against the second covering element 4, more specifically against the side webs 8 of the second covering element 4, by way of the two coupling elements 6, which are in the form of pegs. There, upon the coupling of the covering elements 3, 4, the second travel path segment of the first covering element 3 on its travel path into the stowage position begins. On the second travel path, it is the case here that mechanical coupling exists between the first and second covering elements 3, 4. The coupling elements 6, which are in the present case of peg-like form, then slide into the guide slots 7, which in this example are of funnel-shaped form, and said coupling elements thus effect a transmission of force, which causes the second covering element 4 to be rotated back into the stowage position counter to the spring force of the spring element. The funnel shape is configured such that, during a linear movement of the first covering element 3, the second covering element 4 is rotationally pivoted downward in particular by way of a lower delimiting wall 7a of the guide slot 7. In the stowage position, it is then also the case that the second covering element 4 is held in the stowage position under preload by way of the coupling elements 6.

1. A display device for a motor vehicle, comprising:
a mirror arranged to be movable between a stowage position and a usage position;
a first movably arranged covering element which, for the movement between a stowage position and a usage position, is coupled to an electromechanical drive; and
a second movably arranged covering element,
wherein the display device has a stowage position, in which the mirror and the two covering elements are arranged in a respective associated stowage position, and a usage position, in which the mirror and the two covering elements are arranged in a respective associated usage position, and in the stowage position, the two covering elements at least partially cover the mirror,
the second covering element is, at least in the stowage position, preloaded by a spring element.

2. The display device according to claim 1, wherein in the stowage position of the second covering element, the second covering element is mechanically coupled to the first covering element and is held by the first covering element in the stowage position of the first covering element.

3. The display device according to claim 1, wherein, over a first travel path segment of the first covering element proceeding from the usage position, the first covering element is mechanically decoupled from the second covering element.

4. The display device according to claim 1, wherein, over a second travel path segment of the first covering element as far as a point at which the stowage position of the first covering element is reached, the first covering element is mechanically coupled to the second covering element.

5. The display device according to claim 4, wherein the mechanical coupling is designed such that, by way of linear displacement of the first covering element, the second covering element is moved conjointly.

6. The display device according to claim 4, wherein the first covering element has at least one peg-like coupling element which, over the second travel path segment, engages into a guide slot of the second covering element, with the mechanical coupling being implemented in this way.

7. The display device according to claim 1, wherein the second covering element has an axis of rotation and is pivotable into the associated stowage position and usage position in each case by way of a rotation about said axis of rotation.

8. The display device according to claim 1, wherein the second covering element is of U-shaped form with two side webs, and a funnel-shaped guide slot is arranged on an inner side surface of at least one side web.

9. The display device according to claim 1, wherein the first and/or the second covering element has a light-absorbing surface on an inner side which, in the stowage position and/or in the usage position, faces toward the mirror.

10. The display device according to claim 1, wherein the mirror is mechanically coupled to the drive of the first covering element and can be pivoted by said drive.

11. The display device according to claim 10, wherein the mirror has a carrier bracket which is mechanically coupled at least to a guide slot which is laterally integrated with a toothed wheel of a mechanism of the drive.

12. The display device according to claim 1, wherein the first covering element has an integrated, rectilinear, toothed structure which directly meshes, with a toothed wheel of the drive.

13. The display device according to claim 1, which is in the form of a head-up display.

14. Motor vehicle having a display device according to claim 1.

15. A method for operating a display device for a motor vehicle, the display device comprising:
a mirror arranged to be movable between a stowage position and a usage position;
a first movably arranged covering element which, for the movement between a stowage position and a usage position, is coupled to an electromechanical drive; and
a second movably arranged covering element,
the method comprising:
arranging the mirror, the first moveably arranged covering element, and the second movably arranged covering element in a respective associated stowage position, and a usage position of the display device;
arranging the mirror and the first and second covering elements in a respective associated usage position,
wherein in the stowage position, the first and second covering elements at least partially cover the mirror; and
preloading the second covering element, in the stowage position, with a spring element.
